(19) United States
(12) Patent Application Publication
(10) Pub. No.: US 2026/0237981 A1
(43) Pub. Date: Aug. 13, 2026

(54) AN ELECTRICAL PANEL WITH AN ELECTRICAL CONDUCTOR MANUFACTURED BY ADDITIVE MANUFACTURING

(71) Applicant: KK Wind Solutions A/S, Ikast (DK)

(72) Inventors: Bjorn Rannestad, Aalborg (DK); Jorgen Dahl Vestergaard, Kibaek (DK); Poul Thing, Ikast (DK)

(21) Appl. No.: 19/469,473

(22) PCT Filed: Mar. 22, 2024
(86) PCT No.: PCT/DK2024/050072

§ 371 Date: Sep. 26, 2025

(30) Foreign Application Priority Data
Mar. 28, 2023 (DK) PA202370156
Apr. 27, 2023 (DK) PA202370206
May 26, 2023 (DK) PA202370265

(51) Int. Cl. H02B 1/56; B33Y 80/00; H02B 1/20; H02B 1/32

(52) U.S. Cl. CPC H02B 1/56; B33Y 80/00; H02B 1/20; H02B 1/32

(57) ABSTRACT

An electric current distribution system includes one or more current input terminals, one or more main busbars, a plurality of transition busbar and one or more current output terminals. At least one of the one or more main busbars or at least one of the plurality of transition busbars are manufactured by an additive manufacturing process.

### FIELD OF THE INVENTION

The invention relates to an electrical distribution system and an electric cabinet assembly comprising transition busbars manufactured by additive manufacturing.

### BACKGROUND OF THE INVENTION

In the art electrical cabinets for enclosing power electronics are well known. A three phased current to a known electrical cabinet is typically provided by three or six cables one/two for each phase depending on cross-sectional area of the cable and amps. Inside the electrical cabinet, the current is distributed by a plurality of electrical conductors in the form of busbars, cables and wires.

Traditionally, cables or braided conductors are connecting busbars with loads, switches, power modules or other electrical components. Such current distribution system is rigid and adds weight to the electrical panel especially due to the massive aluminium or cobber busbars. The present invention solves these problems as will be described below.

### SUMMARY

The inventors have identified the above-mentioned problems and challenges related to mounting of conductors in cabinets and solved these problems by the present invention as described below.

In an aspect, the invention relates to an electric current distribution system comprises: one or more current input terminals, one or more main busbars, a plurality of transition busbar, and one or more current output terminals, wherein at least one of said one or more main busbars or at least one of said plurality of transition busbars are manufactured by an additive manufacturing process.

Manufacturing one or more a main busbar or one or more transition busbar (commonly referred to as busbar) by an additive manufacturing process is advantageous in that additive manufacturing is suitable for manufacturing complex shapes and is thus advantageous to employ for manufacturing of busbars where these are used in narrow spaces such as in an electrical cabinet. Particularly, geometrical features of the busbar, such as individual conductor branches, outgrowths, recesses, internal structures, etc. may be directly manufactured additively. Thus, using additive manufacturing for manufacturing a busbar of a high-power converter is advantageous since it may permit tailoring the geometry of the busbar to the conditions/design of the electric current distribution system and thus to the electrical cabinet comprising the electrical current distribution system.

Hence, an electrical current distribution system according to the present invention comprising a busbar manufactured by an additive manufacturing process is advantageous in that weight and cost of materials are reduce due to less material being used for the busbars. Further, cooling of the electrical cabinet is improved in that surface area of the busbar can be increased and the busbar can be manufactured with internal cooling channels. Further, assembling of the electrical current distribution system and thus of the electric cabinet may be faster due to a reduced number of connections of busbars and to more flexible busbars compared known busbars. These effects may all contributed to a more compact design of the current distribution system.

Further, the busbars may be designed to reduce airflow from an air inlet to an air outlet of an electric cabinet as little as possible. In fact, it may be possible to design the busbars with a geometry that is guiding air flow in a predetermined direction. A predetermined direction may be towards a heat sink, a connection between conductor and component, an opening to an internal channel of the busbar, etc.

In an exemplary embodiment of the invention, wherein one or more supply cable is electrical and mechanical connected to said one or more current input terminals.

In this way, the current distribution system is connected to external system such as generators, grid, etc. The input terminals may be implemented as holes in the main busbar or in a transition busbar.

The connection between the input terminal and supply cable may be made via bolts penetrating terminal holes in the cable shoes of the supply cable and terminal holes referred to as input terminals.

Regarding the reduction of used material and thereby weight of the distribution system. This may be obtained e.g. by cutting of a corner of e.g. a transition busbar. This is easy in that the conductor is manufactured by an additive manufacturing process and thus easy to print. As an example of this could be mentioned a transition busbar meant for collecting current from e.g. three cables and guide this current to a main busbar. The part of the transition busbar conducting current from one cable should have first cross-sectional area, the part conducting current from two cables a second cross-sectional area larger than the first cross-sectional area and the part conducting current from three cables a third cross-sectional area larger than the first and second cross-sectional areas.

In an exemplary embodiment of the invention, wherein a cross-sectional part of at least one of said one or more main busbars or one of said plurality of transition busbars comprising a through-hole and wherein said cross-sectional part of said at least one of said one or more main busbars or one of said plurality of transition busbars is increased.

This is advantageous in that it has the effect, that the cross-sectional area that is available for conducting current is not reduced even though a through hole is made through the high-power electrical conductor. An increased/decreased cross-sectional area or a conductor should be understood as along the length of the conductor, the cross-sectional areas is changing (increasing or decreasing). Hence, if the cross-sectional area is measured a first distance from an end and a second distance from the same end, the cross-sectional area of the conductor may not be the same. It should be noted, that the same is true for the circumference of the conductor. In other words the length around the circumference of the conductor and/or the width of the conductor may change (decrease or increase) along the length of the conductor.

In an exemplary embodiment of the invention, said at least one of said one or more main busbars or one of said plurality of transition busbars has a wedge-shaped geometry.

Such geometry is advantageous if e.g. three cables conducting the same phase current is to be connected to one main busbar. Then the three supply cables connected to a wedge-shaped electrical conductor is advantageous in that material for the end segment of the wedge-shaped transition busbar is saved at the end where only current from one of the cables is conducted. The end segment of the wedge-shaped conductor conducting current from only one cable does not require the same amount of electric conductive material as the end segment conducting current from all three cables.

In an exemplary embodiment of the invention, said electric distribution system is comprised by an electric cabinet.

In an exemplary embodiment of the invention, said electric current distribution system comprises a current balancing busbar.

A main busbar should be understood as an electrical conductor distributing current in an electrical cabinet, a switchgear, panel board or busway enclosure, typically, from one or more cables entering the electrical cabinet to electrical components located inside the electrical cabinet. Typically, the main busbar extends in the width (X direction) or in the hight (Y direction) of the electrical cabinet. The main busbar may be fastened to the back plate of the electrical cabinet.

A transition busbar should be understood as a busbar connecting a main busbar or cable with another main busbar, another transition busbar, with an electrical component, or the like. A transition busbar may also be referred to as a connection or transition piece for connecting two or more electrical components. Typically, a transition busbar extends in two or more directions, where one of these directions is towards the opening of the electrical cabinet (Z direction). Another of these directions is typically perpendicular or parallel to e.g. the main busbar to which transition busbar is connected. The transition busbar may comprise two legs at one end for connecting e.g. two paralleled power modules to one main busbar or to another transition busbar.

A current balancing busbar should be understood as a variant of a transition busbar. A current balancing busbar may e.g. be a transition busbar having two or more legs or sets of terminals allowing the connection of two or more power modules i.e. allowing parallelling the power modules. This is advantageous in that it has the effect, that if such current balancing busbar is connected to e.g. two power modules, then the current into or out of these two power modules can be balanced. Such balancing is done via designing the current balancing busbar so that the current path through the two legs of the current balancing busbar has the same ohmic resistance. When this is achieved an equal share of current to and from the power modules is conducted via the two legs. Thereby it is achieved that losses are the same in both legs leading to equal wear and temperature increase.

In an exemplary embodiment of the invention, at least one of said one or more main busbars or one of said plurality of transition busbars is manufactured at least partly with a concave geometry in the surface of a middle segment or in one of a first end and a second end of said at least one of said one or more main busbars or one of said plurality of transition busbars.

This is advantageous in that such concave geometry may form a funnel like geometry guiding a flow of air caught by said funnel to an inlet opening of an internal cooling channel of said electrical conductor or through the electrical conductor if the design thereof allows so. It should be mentioned that air guides provided in the surface of said electrical conductor may assist in guiding a flow of air into said funnel.

It should be noted that the air guides described in this document may also be applied to or made in the surface of the ends of the electrical conductor.

In an exemplary embodiment of the invention, at least one of said first end and said second end is monolithically formed with said middle segment.

In an exemplary embodiment of the invention, at least one of said one or more main busbars or one of said plurality of transition busbars are manufactured with an airy geometry.

Airy design should be understood as a design comprising one or more conductor branches designed in such a way that air or other cooling fluid may pass through the conductor branches and thereby facilitate cooling the conductor branches. Examples of such an airy design include weblike, spongy, bionic, twisted, etc.

In an exemplary embodiment of the invention, said electrical conductor has a resonance vibration frequency of at least 5 Hz, for example at least 20 Hz, for example at least 30 Hz, for example at least 70 Hz, for example at least 150 Hz for example at least 300 Hz, for example at least 500 Hz.

The electrical conductor is advantageously designed and subsequent manufactured so that it has a resonance vibration frequency associated with relative motion between the first end segment and the second end segment that is does not coincide with a natural frequency of the system in which it is included. This is to avoid vibrations initiated by natural frequencies from such electric system or mechanical system. An example of a mechanical system is a wind turbine which may have a natural frequency of 5Hz.

In an exemplary embodiment of the invention, at least a middle segment of at least one of said one or more main busbars or one of said plurality of transition busbars comprises at least one internal channel.

Said internal channel may be a closed channel for guiding a liquid through the interior of the busbar or an open channel for guiding an air flow through the interior of the busbar. It should be mentioned that guiding an air flow through the interior of the busbar should be understood as guiding air behind the outer surface of the busbar i.e., along the side or behind a conductor branch of the busbar. Accordingly, it is understood that the conductor, in particular part of the middle segment of the conductor is manufactured with a plurality of conductor branches forming air gaps through which air can flow.

In an exemplary embodiment of the invention, said at least one internal channel is included in a cooling loop and configured to guide a cooling fluid circulated in said cooling loop through the interior of said at least one of said main busbar or said transition busbar via said at least one internal channel.

An internal channel configured to guide a cooling fluid through at least part of the busbar (note that busbar may refer to either one of a high-power electrical conductor, electrical conductor, conductor, main busbar, transition busbar and current sharing busbar) is advantageous in that in this way, the temperature of the high-power electrical conductor, especially around the internal channel, can be controlled such as reduced. Hence, an internal channel is advantageous in that it has the effect, that an efficient temperature regulation of the electrical conductor is possible.

Further, internal channels are advantageous in that heat is transported out of the electrical cabinet more efficiently than by using a fan to establish a flow of air out of the electrical cabinet. Since, at the high amps a power converter of the present invention is operating at, heat is a very important design factor. Thus, the better the temperature can be controlled, more efficient it is possible to operate the power converter. Therefore, it is important to be able to remove as much heat as possible from the inside of the electrical cabinet.

Accordingly, electrical conductors having both an internal channel for liquid fluid and a bionic-like geometry is advantageous to use for conducting current inside an electrical cabinet comprising the electric current distribution system operating with currents above 500 A.

In an exemplary embodiment of the invention, at least one of said main busbar or one of said plurality of transition busbars comprises at least two, preferably at least three, most preferably at least four internal channels.

Having more than one internal channel is advantageous in that it has the effect, that the busbar then has more surface when high frequency current is conducted due to the skin effect. Further, this is advantageous in that it has the effect, that a larger part of the cross-sectional area of the busbar is possible to temperature regulate. Further, this is advantageous in that it has the effect, that cooling fluid having different temperatures can flow through the electrical conductor. A plurality of channels also allows to circulate the same cooling fluid forth and back between the ends of the middle segment/first and second ends. Alternative, it allows to have several separate flows.

In an exemplary embodiment of the invention, said at least one internal channel is configured to comprise a cooling pipe.

A cooling pipe/polymer tube e.g. in the form of an insulated hose may be inserted into the internal channel e.g. when the busbar with internal channel is manufactured. This is advantageous in that it has the effect, that no connection of external channel and internal channel is needed. The cooling pipe may simple be circulating the cooling fluid from a heat exchanger to through the busbar via the internal channel and back to the heat exchanger.

Cooling fluid may e.g. be selected as a type of oil which may also be non-electrical conductive and thereby work as both cooling fluid and isolator, water, deionized water, Glycol, liquid, metal such as Gallium, mercury, etc.

In an exemplary embodiment of the invention, said at least one internal channel is monolithically formed with at least part of an external channel.

Monolithically formed or uniting the internal channel and at least part of an external (to the electrical conductor) channel is advantage in that mounting of the internal channel to a cooling system is easy. In fact, an additional part of the external channel such as a plastic pipe may be connected to the part of the external channel monolithically formed with the inner channel with a hose clamp.

In practice, the external channel may be made of the material of the busbar and the internal channel is defined by removal or non-existence of such material. Thus, the internal and external channels are not two physical channels that are united, rather the external channel is an extension of the internal channel.

In an exemplary embodiment of the invention, at least one of said one or more main busbars or one said plurality of transition busbars comprises at least one air guide.

A busbar comprising an air guide is advantageous in that it has the effect, that it facilitates both guiding a cooling fluid, such as air, to and possible also around an electrical component to which it is connected or passing by in an electrical cabinet. Such catching and guiding of air flow is achieved while, at the same time, improving the cooling of the busbar itself and supplying the electrical component with power without the need for additional air guiding components.

In an exemplary embodiment of the invention, said at least one air guide is removably attached to one of said one or more main busbars or one of said plurality of transition busbars.

This is advantageous in that it has the effect, that it is possible to adjust the position of the air guide on the busbar. Thus, it is possible to adjust airflow directly to a hot spot e.g. of an electrical component or an area which need cooling by airflow.

In fact, it may be possible during operation of an electrical system to establish a thermography of the electrical system and based on an evaluation of the resulting picture adjust or position one or more the air guides to guide flow of air to relevant areas.

In an exemplary embodiment of the invention, said at least one air guide is an integrated part of at least one of said one or more main busbars or one of said plurality of transition busbars.

An integrated air guide is advantageous in that it has the effect, that no additional components is needed to distribute an air flow around or along the busbar.

In an exemplary embodiment of the invention, at least one of said one or more main busbars or one of said plurality of transition busbar comprises at least one integrated heat sink.

A busbar such as a middle segment hereof comprising an integrated heat sink is advantageous in that not only does such busbar facilitate improved cooling of the busbar itself, e.g. when used as a high-power busbar for conducting currents to or from a component to which it is connected. But such middle segment advantageously also enabling cooling of a component such as a power electronic component such as a power module by mounting the power modules with a thermal connection to the busbar with an integrated heat sink. Thereby eliminating or reducing the need of separate heat sinks for components such as the power module.

The heat sink may provide a larger surface area of the busbar where it is located compared to other parts of the busbar where no heat sink is located.

In addition, or alternatively a heat sink may provide a more open surface of the busbar, particularly of the middle segment, compared to parts of the busbar which have no heat sink.

In an exemplary embodiment of the invention, said at least one heat sink is removably attached to one of said one or more main busbars or one of said plurality of transition busbars.

This is advantageous in that it has the effect, that it is possible to adjust the position of the heat sink on the busbar. Thus, it is possible to adjust heat sink capacity directly to a hot spot e.g. of a busbar or an area which need cooling by airflow.

In fact, it may be possible during operation of an electrical system to establish a thermography of the electrical system and based on an evaluation of the resulting picture adjust or position one or more heat sinks to increase cooling at relevant areas.

In an exemplary embodiment of the invention, said at least one heat sink is an integrated part of one of said one or more main busbars or one of said plurality of transitional busbar.

In an aspect, the invention relates to the use of a main busbar or transition busbar according to any of the preceding claims in a renewable energy generating facility.

A renewable energy generating facility should be understood a wind turbine, windfarm, solar panel, solarfarm, etc. including substations needed to connect the renewable energy generating facility to the utility grid.

In an aspect, the invention relates to an electric cabinet assembly, said electrical cabinet assembly comprising: an electric cabinet, a power conduction section comprising one or more main busbars, a power handling section comprising a plurality of electrical components, and a plurality of transition busbars wherein at least part of said plurality of electrical components of said power handling section is connected to one of said one or more main busbar via one of said plurality of transition busbars, characterised in that at least one of said plurality of translation busbars is manufactured by an additive manufacturing process.

An electric cabinet assembly comprising components that are connected by conductors that are manufactured by additive manufacturing may have an airy design or geometry leading to an optimized cooling.

Further such busbars may be manufactured with an integrated heat sink, with air guides, etc. which may optimize cooling of the conductor and reduce the amount of material needed to manufacture the conductor. This leads to a reduction of weight of the cabinet assembly which has many spillover effects e.g. in terms of logistics and support of the cabinet assembly.

In an exemplary embodiment of the invention, said electric cabinet assembly further comprises a filtering section comprising a reactor.

In an exemplary embodiment of the invention, said electric cabinet assembly further comprises a cooling system.

In an exemplary embodiment of the invention, said cooling system is configured for local cooling of at least one of said one or more main busbars or one of said plurality of transition busbars.

In an exemplary embodiment of the invention, at least one of said one or more main busbars or one of said plurality of transition busbars are manufactured with an internal channel configured for conducting a fluid.

An internal channel may be used to circulate a fluid with which it is possible to regulate temperature of the busbar comprising the internal channel. In this way it is possible to either increase or decrease the temperature of the busbar and thereby of the cabinet in which the busbar is enclosed. This is advantageous in that it has the effect, that drips of water e.g. condensation on the busbar can be vaporized prior to conducting current through the busbar. In this way the risk of arc flash occurring is reduced.

In an exemplary embodiment of the invention, said internal channel is a channel for conducting a cooling fluid.

This is advantageous in that it has the effect that the busbar can be cooled from the inside by a flow of cooling liquid which is advantageous over a cooling air in that the liquid cooling is more focused and heat can be removed faster from the electric panel via the cooling liquid.

In an exemplary embodiment of the invention, said at least one of said one or more main busbars or at least one of said plurality of transition busbars is included in a closed liquid cooling loop of said cooling system.

This is advantageous in that it has the effect, that heat is transported directly from the inside of the busbar and out of the electric cabinet. In this way the temperature is reduced inside the electric cabinet leading to better working conditions of the power modules. Alternatively or in addition, it may lead to an increase in current possible to conductor to the power modules and/or handled by the power modules in that temperature is no longer as limiting a factor compered to power modules of known electric cabinet only cooled by an air flow on the outside of the electrical conductor.

In an exemplary embodiment of the invention, at least one of said one or more main busbars or at least one of said plurality of transition busbars is cooled by a fan.

This is advantageous if the busbar is manufactured in an airy design where cooling air can pass through two or more conductor branches of the busbar geometry.

### THE DRAWINGS

For a more complete understanding of this disclosure, reference is now made to the following brief description, taken in connection with the accompanying drawings and detailed description, wherein like reference numerals represent like parts. The drawings illustrate embodiment of the invention and elements of different drawings can be combined within the scope of the invention:

FIG. 1a-c illustrates various electrical conductor according to the present invention,

FIG. 1d illustrates an electrical conductor in a twisted design with an inductor part according to an embodiment of the invention.

FIG. 1e illustrates an electrical conductor

FIG. 2 illustrates a flowchart according to a method of a manufacturing an electrical conductor,

FIG. 3 illustrates an electric current distribution system,

FIG. 4 illustrates a top view of a busbar with through holes,

FIG. 5 illustrates a side view of a busbar with concave,

FIG. 6 illustrates an end view of a busbar with an integrated heat sink, and

FIG. 7 illustrates a busbar with an internal channel.

### DETAILED DESCRIPTION

The present invention is described in view of exemplary embodiments only intended to illustrate the principles and implementation of the present invention. The skilled person will be able to provide several embodiments within the scope of the claims.

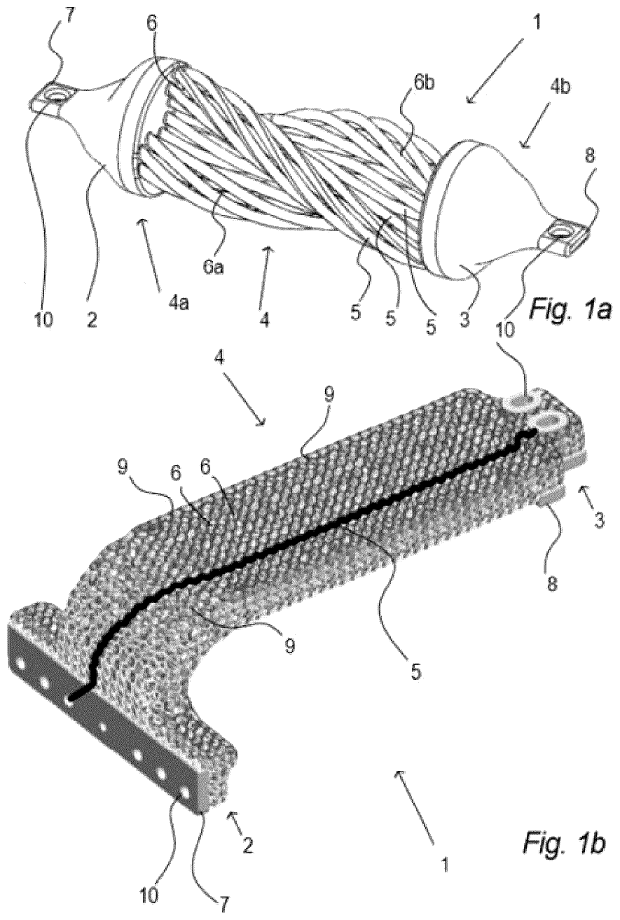

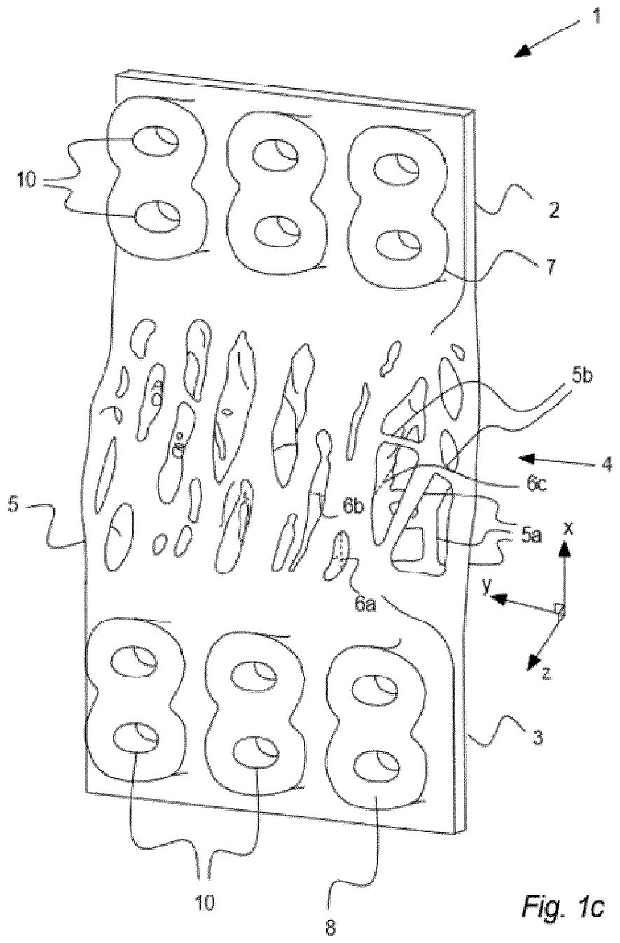

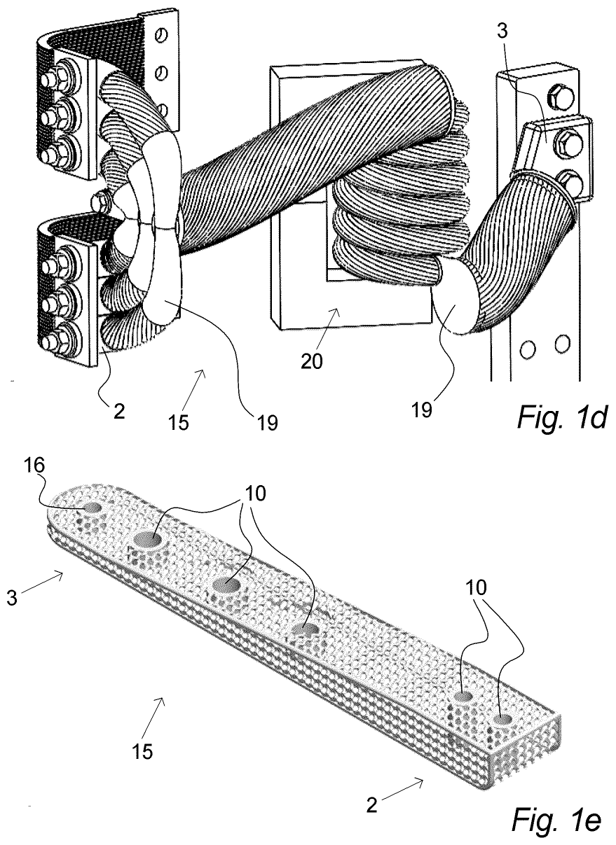

FIG. 1a-1c illustrates various embodiments of an electrical conductor 1 for use in a distribution system 11 of the present invention. FIG. 1a illustrates an electrical conductor 1 having a twisted geometry/design. The electrical conductor 1 comprises a first end 2 and a second end 3, where the second end 3 being distal to the first end 2 and spaced apart from each other by a middle segment 4.

The middle section 4 in this particular embodiment comprises a plurality of conductor branches 5. In this particular embodiment the individual conductor branches are spaced apart by air gaps 6 both in the longitudinal and 6a transversal direction 6b of the electrical conductor 1. This twisted design of the conductor branches adds flexibility to the conductor 1 and thus the ability to absorb vibrations. Further, the design is lightweight and easy to mount.

In this particular embodiment, the first end 2 comprises a first terminal 7 and the second end 3 comprises a second terminal 8. The first and second terminals 7, 8 may comprise one or more terminal holes 10 for connecting the electrical conductor 1 to other electrical components. The electrical conductor 1 is configured to support conductance of an electric current between the first and second terminals 7, 8.

Each of these two terminals 7, 8 may, via terminal holes 10, clamps, plugs or other electrical connection means, for example be galvanically coupled to terminals, busbars, components (such as breakers, contactors, power modules, reactors, etc.) and other electrical conductors according to the present invention, etc. of an electrical installation such as a distribution system 11. Typically, the electrical conductor 1 and thus the terminals, busbars, components, etc. to which it may be connected would be comprised by an electric box i.e. located inside an enclosure such as a panel, cabinet, etc.

In various embodiments, the electrical conductor 1 may have several first ends 2, several second ends 3, several first terminals 7, and/or several second terminals 8.

FIG. 1b illustrates an electrical conductor 1 having a web-like or lattice-like geometry/design. As the electrical conductor 1 illustrated in FIG. 1a, the electrical conductor illustrated in FIG. 1b comprises a first end 2 and a second end 3 separated by a middle section 4. The first end 2 may comprise a first terminal 7 and the second end 3 may comprise a second terminal 8. The first and second terminals 7, 8 may comprise one or more terminal holes 10 for connecting the electrical conductor 1 to other electrical components.

Between the two terminals 7, 8 conductor branches 5 in a web-like structure extend (only one is highlighted). These conductor branches meet and branch off in a plurality of intersection points 9. Note that the first and second ends 2, 3 are also partly manufactured as a web-like design as the middle segment 4. Also note, that the first and second terminals 7, 8 comprise more than one terminal hole 10. The terminal holes 10 of the terminals 7, 8 is made in a part of the ends 2, 3 which has non-perforated surface i.e. a surface different from the web-like surface of e.g. the middle segment 4 of the electrical conductor in this particular embodiment. The planar contact surface of the terminals 7, 8 around the terminal holes 10 is preferred to provide a connection surface to another flat surface with as little resistance as possible and sufficiently strong contact surface between bolt/nut and electrical conductor 1.

FIG. 1c illustrate an electrical conductor having a bionic geometry/design. As the electrical conductor 1 illustrated in FIG. 1a and 1b, the electrical conductor illustrated in FIG. 1c comprises a first end 2 and a second end 3 separated by a middle section 4. The first end 2 may comprise a first terminal 7 and the second end 3 may comprise a second terminal 8. The first and second terminals 7, 8 may comprise one or more terminal holes 10 for connecting the electrical conductor 1 to other electrical components.

The middle segment 4 in this embodiment is of a so-called bionic design, preferably achieved as a computer generated design. Such computer-generated design is provided based on input to a computer program controlling an additive manufacturing machine/process or able to export data to a controller of an additive manufacturing machine/process such as from a user or another computer. Input may include dimension, maximum current to be conducted, required strength, maximum deflection (elastic or plastic), etc. As the electrical conductor illustrated in FIG. 1b, the electrical conductor of this particular embodiment comprises both longitudinal conductor branches 5a and transversal conductor branches 5b. It is noted, that together the conductor branches 5a, 5b forms a transversal conductor branch outgrowth i.e. if seen in a side view, the electrical conductor 1 of FIG. 1c would be thicker at the middle section 4 than at the ends 2, 3. The conductor branches 5 are spaced apart in space by air gaps 6 in both X (6a), Y (6b) and Z (6c) directions. Further note, that the terminals 7, 8 are designed with a planar surface to obtain best possible contact with a component having a planar surface, to which the electrical conductor 1 is to be connected to, such as clamped against, via for example bolt and nuts. Also note, that independent from the geometry of the ends 2,3, the terminals 7,8 are aligned/raised so that the contact surface for, e.g., all three terminals 7 are in the same plane.

The above embodiments of an electrical conductor 1 all feature airy geometries having air gaps 6 between conductor branches 5. The electrical conductor 1 may in other embodiments feature other airy geometries such as web-like, gyroid-like, lattice-like, etc., as described in more detail herein, which in various embodiments may provide improved cooling, reduced material consumption, improved flexibility, and/or other advantages described in more detail herein. The term ‘-like’ is used in connection with gyroid-like, lattice-like, etc., to emphasize that it is an airy geometry resembling the named structure, rather than a specific systematic structure, that is relevant in preferred embodiments of the invention.

It should be noted that the three different designs of electrical conductors illustrated in FIG. 1a-1c is not limiting for the designs or geometries or structures that is possible to manufacture according to the present invention. Other designs that are possible to represent digitally and transfer to an additive manufacturing device and thus manufacture by additive manufacturing is considered to fall with the scope of the present invention. This includes designs having plane surfaces with internal ducts, manufactured by different materials, manufactures with protrusions or recesses, manufactured to have auxiliary functions beside conducting current, etc. Particularly, high-power conductors are advantageous to manufacture according to the present invention.

Note that embodiment of the invention, such as the above-described electrical conductors, may comprise further terminals 7, 8 between the ends 2, 3, which are not illustrated. Also note, that a plurality of the illustrated electrical conductors 1 may be connected to form a complete electrical conductor. In this case the first and second end 2, 3, is referred to as the ends of the complete electrical conductor which may comprise terminals 7,8 and e.g. terminal holes 10 for connecting the complete electrical conductor to other components. Between these first and second ends 2, 3 of the complete electrical conductor, terminals 7, 8 of a plurality of electrical conductors as illustrated may be connected.

The cross-sectional area of the conductor/conductor branches can be exploited to its full potential in an electrical conductor of the present invention. The conductor is designed and manufacture to have a cross-sectional area that is able to comply with requirements to current to be conducted without have excess of material used. The design of the present conductor may not have surplus material which is not used for conducting current when nominal current is supplied e.g. to a 1400 A power module. If extra material is used, this is used for cooling the conductor or a safety margin. The amount of such extra material can be determined relatively precise by the software which is used to design the conductor. As a rule of thumb, the larger surface for cooling, the higher amps is possible to conduct. The design software may be able to put weight on amps, cooling properties (cooling medium, surface, etc.), frequency of the current when designing the geometry of the conductor, etc. when designing the conductor. Accordingly, a conducting cross-sectional area of a conductor as illustrate in FIG. 1b may be 80 mm2 may in certain embodiments be sufficient to conduct a current of 1300 A due to the airy design allowing a very advantageous cooling. In fact, tests have shown that the temperature of a conventional massive busbar with a conducting cross-sectional area of 516 mm2 conducting 1300 A increases to a temperature where neighboring components of plastic is in risk of melting.

Hence, it should be noted that the conductor may be designed and subsequently manufactured so that a percentage of the cross-sectional area of the electrical conductor e.g., above 80% such as between 90% and 100% is used to conduct current during normal operation. This is in contrary to known massive busbars that does not exploit the material in its center to conductor current. This is at least true for most frequencies of currents conducted in high-power systems including renewable systems, vehicles and the like.

The high percentage of utilization of cross-sectional area for conducting current compared to known massive conductors is possible to obtain in that the conductor of the present invention and thus the individual conductor branches because they are designed with a cross-sectional area that sums up to be able to conduct a current of a given frequency. Further, the material reduction is also made possible because of the possibility of cooling also inside the conductor. In fact, a conductor branch may along most of its length, in some embodiments along all of its length, be cooled from all angles i.e. a 360° cooling of the conductor branches is possible.

As mentioned, a conductor of the present invention may form an airy geometry which depending on the kind of airiness may not facilitate a secure or robust platform or structure for fastening the conductor e.g. to the electric cabinet. Accordingly, in proximity of through-holes for fastening the conductor or through-holes, e.g. terminal holes, for connecting the conductor to components or other conductors, the geometry of the conductor may not be airy. Preferably, around a through-hole the density of the conductor is higher or more concentrated to form an, e.g., planar surface and thereby provide the best possible preconditions for conducting current between two parts of a joint and to distribute the force required to fastening a conductor in the joint or to a support structure. Hence, a through-hole may be designed as a cylinder through which a bolt may pass through and with planar upper and lower parts extending from the periphery of the cylinder to facilitate the force and/or current distribution in the joint. Other mounting and/or terminal points may be preferred in some embodiments, such as flanges, protrusions, plugs or sockets, etc., with or without through-holes, but with the same consideration of ensuring sufficient robustness and stability of the electrical conductor for the intended mounting or connection method. The through-holes could be 6 mm, 8 mm, 10 mm or 12 mm in diameter.

It should be mentioned that terminals for electrical connection may be positioned at or between the ends of an electrical conductor. Thus, in principle, a conductor may be manufactured by an additive manufacturing process and when the first end and first part of the middle segment is manufactured these may be rolled onto a conductor holder as the middle segment is continued to be manufactured. Alternative, the conductor is guided out of the printing areas e.g. by a conveyer belt as the conductor is manufactured. This may result in a long conductor with two ends. Either during manufacturing or after, terminals may be made in the conductor and also after manufacturing, the conductor may be cut into desired lengths. In this way, terminals may be manufactured or provided either at the ends or between the ends of the conductor.

The term monolithic is in this description used to describe the geometry or structure of an electrical conductor according to the present invention. Such conductor is preferably manufactured by an additive manufacturing process and thereby, it is manufactured as a single piece, unit or block from one end to the other or at least one end and a middle segment is manufacture as a single piece. Such conductor may thus be formed from a single material as a single piece, unit or block where its one or more ends are monolithically formed with a middle segment connecting the one or more ends i.e. monolithically formed should be understood as made in one continuous process with no need for additionally adding one part to another I.e. one or more ends are manufactured together with the middle segment as one unit with no connections such as welding, soldering, or by any clamping or fastening means, except for the type of micro binding intrinsic to the particular additive manufacturing technology utilized, such as, e.g., layer-by-layer melting, sintering, liquid binding, spraying, etc. With this said, it should be mentioned, that it is possible to add additional elements such as terminals, cooling fins, etc. in a post manufacturing process e.g., by a cold spray process.

Put in another way a conductor of the present invention is the result of a process forming the conductor in one structure, a conductor composed of an electrically conductive material without joints or seams and thus constituting a conductor as a rigid whole exhibiting a rigidly fixed uniformity. To such conductor it is possible to connect additional conductors via terminals and thereby branch off one current path to two or more current paths or vice versa.

It should be mentioned that the conductor may be manufactured from more than one type of material. In this situation, the conductor could be said to be polylithic. The term polylithic should in this context be understood as a geometry or structure of an electrical conductor that is manufactured in one piece as a monolithic structure, as described above, where the conductor is manufactured from two or more materials. Hence, a polylithic conductor of the present invention is a conductor resulting from a process forming the conductor in one structure where the process is using two or more different materials. Such two or more materials may be a combination of electrical conductive or non-conductive materials.

In most embodiments, the electrical conductor 1 is designed to comply with high voltages i.e. voltages above 24V such as 110V, 230V, 400V, 690V, 1000V, 1500V and up to kV systems. just to mention a few voltage levels of an electrical installation in which the electrical conductor 1 of the present invention would be suitable. In terms of current, an electrical conductor 1 according to the present invention may be designed to conduct several hundreds of amps (16, 32, 64, and so on up to 100, 200 and so on up to e.g. 900 A) up to a couple of thousand amps (1000 A-3000 A). Electrical conductors may be designed to conduct higher currents than 3000 A e.g. by improving cooling of the conductor in combination with an increased cross-sectional area of the conducting part of the conductor.

Mentioning these voltages, it should be noted, that in principle there are no lower limits as to the voltage and current. I.e., versions of the electrical conductor may be designed to be used in, e.g., 3.3V, 5V, 9V, 12V, 15V, 20V, 24V or 48V systems, such as USB power delivery PD systems, conducting currents below, e.g., 10 A, such as 5 A, 3 A, 2.4 A, or 2 A just to mention a few examples.

Thus, the electrical conductor 1 of the present invention is suitable for use in almost any type of electrical installation. This includes everything from low voltage to high voltage AC and or DC systems where transfer/conducting of current or communication signals is needed.

The present invention is particularly advantageous for electrical busbars designed for high-power electrical systems, e.g. from 10 kW and up, such as 22 kW, 50 kW, 110 kW, 150 kW, 225 kW, 300 kW,350 KW,500 kW,800 kW,1 MW,2 MW, 3MW, or even higher, such as e.g. 5 MW or 10 MW systems, with voltages of e.g. 110V, 230V, 400V, 690V, 800V, 1000V, 1500V, 6 kV or e.g. 10 kV, and currents from e.g. 16 A, 32 A or 64 A, to several hundreds, e.g. 100 A, 200 A or 500 A, or even thousands, e.g. 1000 A to 4000 A. By local connecting busbar is referred to busbars for local connections inside such a high-power electrical system, e.g. contained inside an electrical cabinet housing a power converter, inverter, transformer, generator, electric motor, breaker, high-power battery system, battery charger, or similar power systems, possibly including capacitors, reactors or inductors, power resistors, dump loads, etc. A system, component or conductor may be categorized as a high-power system, component or conductor if it is operating at currents in the range of 800-1000 A or higher.

Non-limiting examples of such electrical installations/systems include energy facilities such as grid components such as substations with grid support, voltage regulation, power to x plants, etc., energy generating systems such as wind turbines, wind farms, solar plants, etc., electric installations in a private homes and industry, industrial machines, household appliances, etc. and means for transportation such as airplanes, heavy duty vehicles, light duty vehicles such as automobiles, trains, ships, etc.

Accordingly, the electrical conductor may be a high-power electric conductor of a high-power electric system. In a high-power electric system, conductors may be spaced apart and/or isolated from each other with greater distances than what is possible e.g. in an electrical motor. This distance is referred to as a safety clearance and the size of it depends on the voltage differences in the system. Thus, when depending on air as isolator between an otherwise non-isolated busbar/conductor and another conductor or structure of conductive material such as a metal cabinet, the distances must be taken into account in compliance with safety regulations. It should be mentioned that air quality/pollution degree, such as humidity and particle content, may also be relevant for the distance of the safety clearance. In case a conductor is used in a high-voltage system the surface is manufactured to reduce field concentrations.

Further, the cross-sectional area of a current path through a conductor according to the present invention is larger than the cross-sectional area of e.g. a winding of an electric motor. This may be true both with respect to a cross-sectional area at a given point of the conductor and over a distance of e.g. 20 cm or 30 cm in the longitudinal direction of the conductor and physical dimensions.

Current conducting busbars of a high-power installation or system is typically fastened to a structure comprising the system for every 25-35 cm. If the current is conducted by cables, the distance between cable fasteners may be even smaller. The fastening may be made by screwing bolts into a support structure such as an electric cabinet or by screwing clamps to the support structure which is then closed and thereby fastening the cable/busbar. The conducting cables/busbars are of course insulated from the support structure.

In such high-power installations where the primary aim of conductors is to distribute electric energy to components, the magnetic field around a conductor of the present invention is not as important as it is e.g. around a winding of an electrical motor. Thus, since the magnetic field is not the main purpose for manufacturing the electrical conductor for a high-power installation the conductor is typically not designed to have a certain magnetic field when conducting current.

Further, again comparing to e.g. a winding of an electrical motor, a conductor of the present invention would as a general rule be designed with a surface area that is as large as possible to optimize the possible advantages of the invention as described herein. Depending on the purpose of the conductor, the surface may for example be designed for conducting current, conducting current and heat dissipation or heat dissipation. Thus, even though all portions of a conductor of the invention may comprise an electric conductive material, not all portions are necessarily used for conducting current through the conductor. In general, the available area around a conductor is exploited to expand the surface of the conductor for one of, for example, the heat dissipation or current conducting purposes, or other described purposes such as improved flexibility, reduced material consumption, air guidance, etc. The available area is limited by safety clearances to other conductors of different phases having different voltage levels, grounded structures such as elements of an electric cabinet, etc.

An example of a portion of a conductor that is primarily used for non-conducting purposes such as heat dissipation or air guidance, is an outgrowth from the surface of the conductor which is not connected at the distal end of where it is growing from the surface of the conductor. Such outgrowth or protrusion may for heat dissipation purposes preferably comprise some kind of bionic design with airgaps between branches, possibly with a continuous surface towards a direction of air flow for air guidance purposes. Such portions would be referred to as conductor branches if these were part of the middle segment conducting current form one end to the other. Such outgrowth may in principle take any form or geometry exploiting the free space around the area as long as safety clearance distances are maintained. In such examples, the fraction of current conducted by the surface area of the outgrowing conductor portion is very small if not zero.

An example of a portion of a conductor that is only used for conducting a current may in principle not be possible in that heat dissipates even from a solid block and a planar surface. What should be understood by a portion of a conductor primarily used for conducting current, is a varying structure or geometry for a middle segment of the conductor between the first and second terminals. When space is narrowed between components in an electrical system, if other conductors are to be passed, if the conductor has to pass through a current sensor or bushing, etc., the surface area of that particular portion of a conductor middle segment may be reduced to comply with available space, thereby typically increasing the conductor density to achieve a narrower outer dimension. In this example, at this particular portion of the conductor, the current conducting portion of the surface area of the conductor becomes high; possibly so high that a hot spot is created where additional cooling is required to continue to maintain a certain current conduction capacity. Hence, this is an example which may benefit from a combination of the conducting portion with an outgrowth portion, as described above, e.g. on each side of the narrowed part of the conductor. In this way, heat generated at the narrow space can be dissipated via the nearby outgrowths, e.g. further in combination with internal cooling channels.

The internal channel mentioned is mainly for cooling and therefor may be referred to as a cooling channel connected to a cooling system. However, it may also be used for heating such as heating up the fluid conducted therein and use it for heating e.g. during start-up.

An example of a portion of a conductor that is used for both heat dissipation and current conduction is a middle part between the terminals, with an airy design or geometry. In such example, the surface areas having the main purpose of dissipating heat and conducting current, respectively, may be the same or close to be the same. This is due to a geometry comprising conductor branches spaced apart from each other so that a flow of cooling air may pass freely by each conductor branch, i.e., through air gaps defined by the conductor branches. In this example the current conducting surface area is large compared to traditional conductors/busbars and windings e.g. of an electric motor. Another difference between a motor winding and a conductor of the present may be found in the circumference of the conductor. The limited space inside a motor obviously limits the circumference of the winding. This is not the case to the same extent e.g. in an electrical cabinet comprising a conductor of the present invention. More space is available and thus the circumference can be made larger leading to an airy design with airgaps for increased cooling. Further, the cross-sectional area of the individual conductor branches of a conductor according to the present invention is often lower than the cross-sectional area of a motor winding.

As mentioned, the electrical conductor 1 may comprise first and second ends 2, 3 spaced apart by a middle segment 4. One complete or final electrical conductor may comprise a plurality of interconnected electrical conductors 1 of the types illustrated/described above. In such embodiment the illustrated electrical conductors may be used as sections of the final or complete electrical conductor. Thus, a final or complete electrical conductor may comprise first and second ends 2, 3, with a plurality of first and second terminals 7, 8 at the ends or between them, e.g. with terminal holes 10 for connecting a plurality of the illustrated/described electrical conductors to form the final or complete electrical conductor.

The terminals 7, 8 may comprise one or more terminal holes 10 or other structures for connecting the electrical conductor 1 to other electrical conductors such as busbars, cables or the above-described electrical conductors, electrical components such as breakers, power modules, batteries, etc.

Alternatively, in an embodiment, one or both of the terminals 7, 8 of the electrical conductor 1 form part of an electrical component as an alternative to being provided as freely connectable locations at the conductor 1.

A terminal 7, 8 may in a simple embodiment comprise a terminal hole 10 through the terminal 7, 8. Via such hole, a bolt can go through and continue through a component with which the electrical conductor 1 is to be connected. The electrical conductor and the component are then clamped together via a nut and the bolt.

Alternatively, a terminal 7, 8 may be a click terminal that is either designed to receive a click part form a component to which the electrical conductor is the be connected or designed with a click part that is to be inserted into such other components.

Alternatively, a terminal 7, 8 at an end 2, 3 of the electrical conductor may be manufactured with a threat which when engaging with a bolt is able to assist in clamping a component to the electrical conductor 1.

Further, it should be noted, that an electrical conductor as illustrated or a complete electrical conductor comprising a plurality of electrical conductors such as the above described may have more than one first end 2 or more than one second end 3. Hence, one end of an electrical conductor 1 may branch off in e.g. three terminals each with a terminal hole. This may be advantageous in that the geometry of the electrical conductor is then designed specifically to the component to which it is to be connected. Branching off the ends into several terminals may also improve heat dissipation capacity at the possibly denser terminal portions, improve electrical connection between the conductor and components, and avoid additional connection pieces or shunts in order to connect adjacent components to a common conductor.

The middle segment 4 may comprise one, but preferably a plurality of conductor branches 5. The conductor branches 5, like the end segments 2, 3, are at least partly made of an electric conductive material such as copper or aluminium or alloys thereof, enabling the electrical conductor 1 to conduct a current between its terminals 7, 8. The design of the conductor branch(es) 5 may be optimized according to a specific purpose such as cooling, material consumption, flexibility (control in a particular direction), footprint, etc. Thus, depending on which parameter(s) the electrical conductor 1 is designed according to, the conductor branches may be designed as longitudinal cylinders (or other geometries such as oval, square, etc.), web, bionic, gyroid-like design, lattice-like design, branch-like design, or sponge-like design, coil or solenoidal designs, spirals, etc.

Thus, the electrical conductor may have a perforated surface, a non-perforated surface, a massive structure or a structure with internal channels optimizing the electrical conductor according to skin-effect and cooling, etc.

Two or more conductor branches 5 may meet in an intersection point 9 and two or more conductor branches 5 may branch off from an intersection point 9. This has the effect, that an electrical conductor is established that maintain a desired strength (determined yield point) with a minimum of material. Among others, this may reduce the cost of the electrically conductive material and reduce the weight of the conductor. It should be mentioned that two conductor branches meeting in the intersection point 9 may be the same two conductor branches leaving that intersection point 9. Alternatively, two other conductor branches may leave the intersection point, however this may be a question of definition of a conductor branch. Further one conductor branch may branch off to a plurality of conductor branches and a plurality of conductor branches may meet and form a lower number of conductor branches.

Further, it should be mentioned that the electrical conductor 1 may be designed as a plurality of electrical conductors, e.g. as a combination of three phase conductors or as a wire harness or printed circuit board traces of a printed circuit board used for mounting in an electric panel.

At least a first end 2 and a middle segment 4, but preferably also the second end 3, of the electrical conductor 1 of the present invention are monolithically formed, since they are manufacturing from a single bulk of material, which is machined to provide the electrical conductor 1. Here bulk of material should be understood as the material such as electrically conductive material of which the electrical conductor 1 is made, e.g. a solid, powder, liquid, wire, etc. Here machined should be understood as manufactured by additive manufacturing, i.e. the electrical conductor 1 is made in one piece without any mechanical connections of the first end 2, second end 3 and middle segment 4.

Note that more than one type of material, e.g. two bulks of material, may be used to manufacture the electrical conductor. One of such two or more bulks of material may be electrically non-conductive.

Note that in some embodiments it may be necessary to manufacture the electrical conductor in more than one piece. In this situation the electrical conductor may be referred to as a complete or final electrical conductor which comprises a plurality of electrical conductors 1 as described above. This may be the case e.g. if the electrical conductor needs to be mounted in a location where it cannot be inserted unless the electrical conductor is separated in two or more pieces or if the complete electrical conductor has to be larger than what is possible to manufacture by additive manufacturing. In such situation, terminals of two electrical conductors are connected, extending the length of the middle section and thereby the current path between the first end 2 and the second end 3 and thus of the complete electrical conductor. Such connection may be prepared by designing terminal holes in the conductor where, e.g., fish plates or other joints may be fastened and thereby connecting the two middle segments.

It should be noted that the electrical conductor 1 may have a non-uniform geometry/design. The design/geometry may take any machinable/printable shape. Such shape may be optimized according to conducting current (skin effect), cooling, guidance of flow of cooling fluid, other components in a panel, resistance, power loss or current displacements, etc.

In a particular embodiment, the electrical conductor 1 may have a non-uniform diameter (measured in a transversal direction) along the lengthwise direction. A well-defined diameter may nevertheless be determined e.g. at a transversal plane at which that electrical conductor 1 has its smallest diameter.

Moreover, in an embodiment of the invention the perimeter length of the electrical conductor 1 or its conductor branch(es) 5 may vary in transversal planes at different positions in the lengthwise direction of the electrical conductor 1. The perimeter length of a given part of the middle segment may simply be measured as the sum of all lengths of perimeters of branches in a given transversal plane. Hence, the perimeter length at a given part may thus be the length of the perimeter of conductor branches measured across/perpendicular to the longitudinal direction of the electrical conductor at that part. A part of a conductor may also be referred to as a portion of a conductor and should be understood as a reference to a specific portion of the conductor such as an end or middle segment.

The perimeter length of the conductor branches 5 may be the sum of lengths of perimeters of all individual conductor branches 5. As one conductor branch may split from a stem to two or more twigs, i.e. branches of a branch, the perimeter at one part of the conductor branch may be different from one part (e.g. a twig part) to another part (e.g. a stem part). Hence, the sum of lengths of perimeters of the conductor branches may be the sum of all individual twigs or of all the individual stems. In case of multiple different possible perimeter lengths for the conductor parts along the length of the electrical conductor, the smallest perimeter length may preferably be used in calculation of current conduction capability of the electrical conductor 1.

In the same way, the cross-sectional area of an electrical conductor at a given part is measured as the sum of the cross-sectional area of all conductor branches at a given part along the length of the electrical conductor. The cross-sections at that part should be measured perpendicular to the longitudinal direction of the electrical conductor.

In an embodiment, the electrical conductor 1 may comprise one or more cooling channels, where the cooling channel may be placed inside the one or more conductor branches, transversally and/or longitudinally.

The embodiment illustrated in FIG. 1e could be said to be a combination of several embodiments of a transition busbar 15 according to the invention. The busbar 15 illustrated on FIG. 1e is of the twisted type illustrated in FIG. 1a. It has three central body segments 19 one is separating one larger twisted conductor part into six twisted conductor parts individually having a smaller diameter than the larger twisted conductor. The other two are connecting the first and a second larger twisted conductor part with the inductor part 20. The six twisted conductor parts each terminates in a first end segment 2. These six first end segments 2 are connected to an additional electric component via a nut and bolt connection. The second end segment 3 is also connected to an additional electric component via a nut and bolt connection.

As illustrated the transition busbar 15 comprises an inductor part 20 with five windings. Through each of these windings one ferrite core extend leading to a noise reduction. Hence, by the illustrated busbar 15 design, four ferrite cores are avoided without compromising the noise reduction.

The embodiment illustrated in FIG. 1d is one example of a busbar having different dimensions i.e. a thick part connected to the second end segment 3 and to a thinner inductor part 20 which again is connected to a thick part. This way of designing the electric conductor is advantageous in that it has the effect, that the thinner part (inductor part 20) of the busbar 15 may be coiled around a core. The core may be a ferrite core as illustrated, but may also be e.g. a core of a transformer or the busbar 15 may be coiled to form a reactor.

By manufacturing the busbar 15 with a thinner part and using this thinner part to coil instead of coiling the thicker part, is leading to a reduction of the size of the ferrite core, transformer core, reactor or the like. This is because the window in e.g. the ferrite core need to by larger if the thicker part is coiled and need to go through the coil compared to a coiled part of the thinner part. The core may be smaller, more compact and thereby weight is reduced, hence, cost of and footprint in the electric system are saved.

Reducing the diameter of course comes with the disadvantage that the thinner part is becoming warmer than the thicker part in that the same current are running through the two parts. However, the busbar 15 may be designed so that it is just before the coiled part starts, the diameter is reduced and just after the coiled part ends, the diameter is reshaped back to the thicker diameter again (as illustrated in FIG. 1e). In such design heat may be dissipated from the coiled/inductor part (thinner part) towards and into the thicker part. Further, the coiled part is small so this part having higher resistance than the remaining part of the busbar is which will reduce the heat generations. Further, the design illustrated where it may be possible to circulate air through the twisted conductor branches, may facilitate better cooling.

FIG. 1e illustrates an embodiment of the invention, where the transition busbar 15 has a geometry shaped as a wedge. A main busbar 14 (also referred to as electrical conductor) comprises a first end 2 and a second end 3 where the second end 3 being distal to the first end 2 and spaced apart from each other by a middle segment 4. The electrical conductor 1 is made of an electrically conductive material.

The busbar 14 illustrated in FIG. 1e comprises two first terminal 7, three second terminal 8 and a through-hole for fastening 16. The current runs from the three second terminals 8 to the two first terminals 7 along the middle segment 4. The two first terminals 7 and the hole serves to support the busbar.

The busbar 15 is thicker in the part where the first terminals 7 are located due to the amount of current running in the electrical conductor 1. As the current conducted by the individual of the three second terminals 8 sums up the total current increases towards the first terminals 7 and hence the thickness of the busbar 15 towards the first terminals 7 increases. Put in another way, the thickness and thus the material consumption can be reduced towards the end of the busbar 15 which conducts 0 A or only current from one cable connected to the first of the second terminals 8.

As mentioned, the busbar 15 shows a through-hole 16 for fastening in the second end 3. The hole 16 is for fastening the busbar 15 in e.g., an electrically cabinet. It is very important to secure the busbar 15 mechanically tight, so the busbar 15 is not affected by vibrations in the system. The fastening to the electric cabinet is isolated. A tight mechanically connecting is also important between the two first terminals 7 and the busbar they connect to, to have a better electrically connecting from the busbar 15 to e.g., the rest of the system in the electrical cabinet which in this case may be another busbar.

Accordingly, the electric conductor described in this document e.g. in FIG. 1e may comprise one first conductor branch that may branch off to a plurality of second conductor branches, each of these second conductor branches may further branch off to a plurality of third conductor branches and so on through the middle segment of the electric conductor. In this way, following the direction of the current flow through the electric conductor from a first end to a second end, current is allowed to flow in the first conductor branch, then allowed to divide into a flow in the second conductor branches and again allowed to divide into a flow in the third conductor branches and so on into additional n^{th} conductor branches.

In an embodiment, if current is flowing from a first end segment to a second end segment, the first conductor branch may have a first cross-sectional area, the second conductor branches may have a second cross-sectional area which is smaller than the first cross-section area. Following, the third conductor branches may have a cross-sectional area smaller than the second cross-sectional area. Accordingly, the cross-sectional area of the conductor branches may be varied in size in the longitudinal direction of the middle segment.

As described above, the conductor branches of the electric conductor may branch off into a plurality of additional (n^{th}) conductors. In the same way, the conductor branches may also converge from a higher number of conductor branches into a lower number of conductor branches.

It should be mentioned that a cross-sectional area of the middle segment at one distance from a first end segment may be the same as a cross-sectional area of the middle segment at a second distance from the first end segment while the number of conductor branches at the first distance is different from the number of conductor branches at the second distance.

Further, it should be mentioned that the cross-sectional area of the middle segment at the first and second distances from a first end segment may be different while the number of conductor branches may be the same. Of course, the cross-sectional area and the number of conductor branches may also be the same at the first and second distances from the first end segment.

The branching off may be in one plane. This plane may be of a tangent to the surface of an electrical conductor having a curved design. Further note that such branching off may either be at the within the fixed uniformity of the conductor and/or it may be from one conductor to another e.g. via a joint/fixing of two conductors.

It should be mentioned that embodiment of the electrical conductor/winding may also include designs where the conductor branches branch off from the first end segment to a plurality of conductor branches and converge again into the second end segment without branching off between the first and second end segments.

Further note that the through-hole through a conductor having an airy design such as in FIG. 1e defining the terminals holes and/or fastening holes may have a solid wall. The solid wall may be of the same or different material as the rest of the conductor and be used to provide strength to the terminal/fastener hole when these are used e.g. to bolt two conductors together or fasten the conductor. The cross-sectional area of the solid wall is determined by the force which e.g. a bolt is applying to the conductor to sufficiently securing the conductor. As an example, the cross-sectional area of the solid walls may be between 0.2 mm and 20 mm such as between 0.3 mm and 15 mm, such as between 0.4 mm and 10 mm such as between 0.5 mm and 0.8 mm.

If the solid wall of a fastening hole is made of the same conducting material as the conductor, the diameter of the fastening hole may be large enough to allow an insulating bushing between the conductor material and the bolt. Such insulating bushing may comprise a collar resting on the surface of the conductor and thereby insulating the bolt head from the conductor material. Such bushing with collar may be manufactured by additive manufacturing. Alternatively, the solid part of the fastening hole can be made of an electrically insulating material. electrically insulating material in form of a filament, e.g. made of thermoplastics such as polylactic acid PLA or acrylonitrile butadiene styrene ABS filament.

Further note that the conductor of the present invention illustrated may be manufactured by additive manufacturing may be manufacture as a curved conductor. i.e. no post processing is needed to bend the conductor. The curve is typically 90 degrees or less, but could in principle be any angle. Such curved conductor may reduce number of connections in a panel and thereby mounting time and also losses in connections conductors.

Further, the conductor of the present invention being manufactured by additive manufacturing may be twisted between 1 degree and 359 degrees. In this way the end segments may be oriented differently and fastened e, g, to other conductors with bolts that are having non-parallel center axis. This is leading to a more flexible design of the layout in a panel and sometimes also easier mounting of the conductors in a panel.

The manufacturing of the electrical conductor 1 may be done by an additive manufacturing process. Such manufacturing process may be based on, but not limited to, one of the following additive manufacturing processes: 3D printing, layer by layer printing, Wire Arc Additive Manufacturing, Fused Deposition Modeling FDM, Direct Energy Deposition, Direct Metal Deposition, sintering based processes, laser based processes, for example Powder Bed Fusion PBF, such as selective laser melting SLM or selective laser sintering SLS, cold spray additive manufacturing CSAM, binder jetting or binder jet 3D printing, etc. It should be mentioned that the actual additive manufacturing process used to print or build the electrical conductor 1 may not be important as long as the material of which the electrical conductor is built is an electrically conductive material.

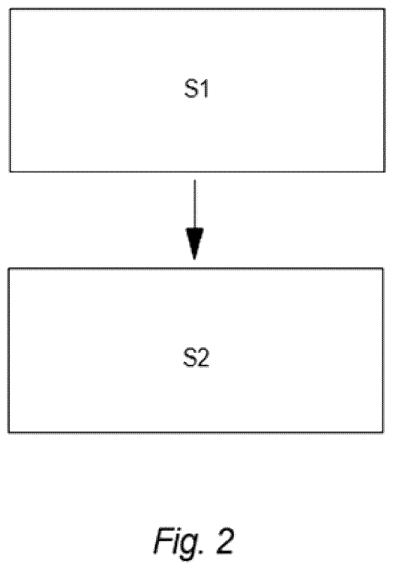

FIG. 2 illustrates method steps for machining an electrical conductor 1 according to an embodiment of the invention. The particular method relates to forming an electrical conductor with two ends or two terminals, namely a first end/terminal and a second end/terminal via a middle segment, but may be used for producing any kind of electrical conductor of the present invention.

It should be mentioned that this may include manufacturing both ends and the middle segment in one process. Hence, with additive manufacturing along the longitudinal direction of the conductor, the method may start by manufacturing, such as printing, one end, then a transition to the middle segment, possibly one or more conductor branches, then the middle segment, then a transition to the second end and finally the second end. In another embodiment, the additive manufacturing occurs transversal to the conductor's longitudinal direction, thereby for example manufacturing portions of both ends and the middle segment simultaneously, increasing the cross section with each applied layer. In another embodiment, the additive manufacturing is radial, or even arbitrary, to the conductor's longitudinal direction, for example using cold spraying CSAM or Fused Deposition Modeling FDM while rotating or freely moving either the conductor unit being built or the nozzle, or both. Preferably, the mentioned segments are manufactured in one process, e.g. as one segment is manufactured, the next segment is being manufactured. A transition part may be made between such two segments which may start or include the first segment. Similarly, the second segment may include a transition part or is connected to such transition part.

It should also be mentioned that the method could in some embodiments comprise manufacturing the middle segment and afterwards connect the end segments. The end segments could be connected while being additive manufactured or could be connected with an additive manufacturing thermal paste or glue after being made. The end segments could also be welded, glued or connected in any other way to the middle segment, e.g. by cold spraying CSAM.

An additional embodiment of the invention could be a manufacturing method that comprises two or more middle segments being additive manufactured. The two or more middle segments could be additive manufactured in the same process with the two end segments to form the electrical conductor. The two or more middle segments could also be additive manufactured separately and connected afterwards to form the electrical conductor.

The two or more middle segments could be identical or could be two differently shaped or otherwise characterized middle segments depending on where the electrical conductor should be placed in e.g., an electrical cabinet.

A transition may straightforwardly be defined as a change of size of a layer compared to a previous layer. In this way a transition may be formed as a perpendicular transition between an end segment and a conductor branch of the middle segment. Alternative, subsequent layers may change in cross-sectional area and thus form a transition as a rounded transition which may be advantageous in terms of a reduced resistance for current conducted between the ends of the electrical conductor.

A monolithic conductor according to the present invention is made from one material. One or more additional materials may be used e.g. as isolation, for heat dissipation, etc. in this case the conductor may be referred to as a polylithic conductor. No matter the number of materials, a conductor produced by additive manufacturing is produced bit-by-bit starting at a first spatial coordinate (x, y, z) and ending at a second spatial coordinate. At least when the conductor is finished the first and second spatial coordinates are electrically/mechanically connected. As mentioned several methods of manufacturing a conductor exists all including some kind of material depositing, joining or soldering to manufacture a conductor in one monolithic form.

In this document a conductor may be referred to as being manufactured layer-by-layer no matter the additive manufacturing method used. Hence, if a conductor is sliced (no matter in which orientation) and one is looking at the cross-section of the conductor it is easy to imagen that the conductor is manufactured starting with material in first point, then with material in a second point and so on. Since the conductor is volumetric i.e. has a three dimensional geometry the first point is different from the second and subsequent points at least in one of the spatial X, Y and Z directions/plans. Thus, with reference to the spatial X, Y and Z planes a conductor could be said to be built from a plurality of subsequent layers even though when manufactured all material in one plane such as X=1 and Y=0 and Z=0 is not provided as a one layer or in one layer before material in a next layer (e.g. an X=2 layer) is provided.

Hence, no matter which of the processes of manufacturing a three-dimensional object such as a conductor that is used, it can be said that the conductor is manufactured layer-by-layer even though some of these manufacturing processes are based on deposited, joined or solidified with material being added together in areas, lines, pointwise, etc. This is because no matter the additive manufacturing process the conductor is manufactured one point after the other. A plurality of points in the same plan (e.g. X=3) is considered one layer also if they are not physically connected in this plane. And when all points of this layer are added, points of the next layer (e.g. X=4) is added to the points in the X=3 layer. As mentioned, a layer may be defined in any of the planes of a spatial Cartesian coordinate system.

Alternatively, the ends may be separate segments that are connected via the middle segment. The middle segment may be printed, and during the manufacturing of the middle segment it may be attached to the ends such as printed, heated, glued or the like onto the ends. The middle segment may be joined to the ends by means of welding, printing, soldering, etc.

It should be noted that the ends may comprise terminals for connecting the electrical conductor to other electric parts/conductors/windings of an electric system. Such terminals may be manufactured like the rest of the electrical conductor by additive manufacturing i.e. monolithically formed with the ends.

In a step S1 of this particular method, considering additively manufacturing a conductor in its longitudinal direction from the first end towards the second end, the first end segment and middle segment in the form of conductor branches of a plurality of conductor branches are monolithically formed via individual transitions that may or may not include rounded connections to shape concavely rounded interior corners between the first end segment and conductor branches of the plurality of conductor branches and to spatially separate conductor branches of said plurality of conductor branches.

The step of monolithically forming the first end segment and conductor branches may be implemented using various methods, for example methods such as additive manufacturing such as 3D printing, casting, and simply removing of material, via machining, from a bulk metal slab to form conductor branches combined with a first end segment.

More specific, a known massive conductor such as a main busbar with a length of e.g. 3-5 m may conduct 1-2 A per mm2. If the same busbar was made in an airy design and e.g. with an internal cooling, then due to the improved cooling the same 1-2 A per mm2 may be conducted with the same efficiency despite the removal of material. Typical conductor materials such as aluminium and copper have temperature coefficients at approximately 0.4%/deg C. If such conductor is efficiently cooled so that the temperature is e.g. 25 deg C. lower compared to a conventional conductor, the resistance is reduced by approximately 10%. Hence approximately 10% of the material can be removed without compromising the losses. Furthermore, in AC conductors the current is not evenly distributed across the conductor volume. Typically, the current density is reduced towards the center of the conductor. Taking such considerations into account can allow for further removal of material without compromising the efficiency of the conductor.

In a step S2 of the method, the first end segment becomes electrically coupled and mechanically coupled to a second end segment via the middle segment of the electrical conductor formed by the plurality of conductor branches. This may also be monolithically achieved, e.g. by continuing the additive manufacturing, as described in step S1.

The coupling of the end segments to the middle segment could also be done by welding, gluing, male/female locking mechanism or any other way that would connect the segments both mechanically and electrically.

An optional, additional step of the method of manufacturing the conductor of the invention comprises a step prior to the step of additive manufacturing any of the first, second or middle segments. The step prior to manufacturing the electrical conductor is a step where a digital representation of the electrical conductor is designed in a software program, e.g. a 3D CAD software. The step of designing the digital representation of electrical conductor in a software program includes taking the electrical, mechanical, structural, geometry and other aspects of the physical electrical conductor into account. Thus, based on these inputs, e.g. provided by a user of the 3D CAD software, a digital representation of the conductor is provided by the 3D CAD software. When the digital representation of the electrical conductor is complete the additive manufacturing process can be started.

A further optional step may be applied i.e. a heat treatment to the finalized conductor. A heat treatment may e.g. be 4 hours at 400 C. and upwards depending on the material. An advantage of heat treatment is that the particles of the manufactured conductor is mutual positioning or merging leading to higher conductivity both thermal and electrical. This is at least true for Aheadd® CP1 20/63 aluminium powders and other aluminium-iron-zirconium power solutions. Such powders may be used in laser powder bed fusion machineries. Using this type of power and heat treatment may lead to higher thermal stability, thermal conductivity, corrosion performance and surface finishing as well as higher electrical conductivity.

The middle segment may in principle have any design/geometry, for example providing flexibility thereto allowing the electrical conductor to deform. It may be formed by conductor branches being solid or having internal cavities to reduce the amount of material that is needed to manufacture the electrical conductor. It may be formed by a web or as a hybrid between conductor branches or web just to mention a few possible designs.

Internal cavities may be used as cooling channels and/or additional surface for conducting high frequency current. Accordingly, the end segments and middle segments may be designed for the particular panel/electric system in which it is used, for a particular type of current to conduct, for having a desired or dual functionality, etc.

One such functionality, beside the above-mentioned may be as a structural support. Hence, if needed the electrical conductor may be designed to assist in carrying the weight of electric components connected thereto. Hence, its dimensions may be larger than what is needed by it for carrying the required current. Similarly, its geometry may be designed for the combined purpose of mechanical support and electric conductance. This is especially true if such support is flexible/deformable in that it may both assist in supporting and at the same time assist in absorbing vibrations.

It should be mentioned that the electrical conductor 1 may be manufactured in two or more resolutions. The thicker layer the faster manufacturing. The layer thickness depends on the material and printing apparatus and may vary from a few millimetres to 20 um, using some combinations the layer thickness is between 50 um and 150 um. In case of additive manufacturing resolution may be defined by thickness of the layers of which the electrical conductor is built (another word for machined and processed). A first resolution that is finer i.e. having thinner layer size than a second resolution may be used when manufacturing the interface between the electrical conductor and the part to which it is connected. Such interface may be the part of the terminal that is in contact with the other part. Alternatively, resolution may be determined by material deposition rate, material flow rate, etc. depending on the type of additive manufacturing used.

To avoid electric losses in connections between two electrical conductors it is preferred that the two parts have mating surfaces, which is most simply achieved by having planar surfaces, but may also be achieved by convex and concave combinations, mortise or finger joints, engaging teeth, cylinder and peg, tongue and groove, slide lock, etc., to further achieve additional advantages, e.g. larger surface area of connection, easier assembly of electrical conductors such as busbars in electrical systems by self-locking, etc., as long as good electrical connection is prioritized. The finer these interfaces are manufactured the better/the less post manufacturing processing is needed to ensure sufficiently mating surfaces, such as planar surfaces.

The second resolution manufactured e.g. with thicker layers would be more rough leading to more surface area. At least for middle and high frequency currents this may lead to conductance of more current without increasing the need for material/dimensions of the conductor. In fact, the middle segment may be manufactured intentionally with a corrugated surface to increase the current-carrying outer surface of the electrical conductor (current-carrying with medium and high frequencies) because of more efficient cooling due to the turbulence of, e.g., cooling air flow created due to the corrugated surface. It should be noted, that if the conductor includes an interior space, the inner surface of the conductors creating such interior space may also be corrugated for the same purpose. A corrugated surface has the effect, apart from offering a larger surface area, that it introduces turbulence in the flow of cooling fluid such as air. Increased speed of cooling fluid may lead to higher cooling effect.

As an example, the depth into the conductor which is used for conducting current at medium and high frequencies may in a specific embodiment be approximate 1.5 mm. In this specific example, the conductor is made of copper with a resistivity of approximate 1.68 μΩcm, a relative permeability of approximate 1 at a frequency of 2 kHz. Thus, a conductor for this particular embodiment may be hollow having conductor thickness of 2 times 1.5 mm. In practice such conductor may be manufactured with a thickness of 4-5 mm leaving room for a cooling in the interior or simple reduction of conductor material and thereby weight.

Knowing that skin effect also appears at e.g. 50 Hz, a reference to a medium frequency with respect to skin effect is a reference to frequency starting around 500 Hz where the design of the conductor may account for the skin effect. The medium frequency range may be between 500 Hz and 10 kHz, above 10 kHz may be referred to as high frequency where skin effect is a fact (the higher frequency, the closer to the surface the current will be conducted).

Further, it should be mentioned that the outer surface may also be corrugated or designed with fins for increasing heat dissipation from the electrical conductor.

The electrical conductor resulting from the method may be used as an electrical conductor of an electrical installation. The electrical installation may be an electric panel which may be part of a renewable energy facility such as a wind turbine, solar system, grid, substation, etc. The electrical installation or system in which the electrical conductor is used may be an electric vehicle, battery system, power to x facility, ship or other minor or larger electric systems. Further, an electrical conductor resulting from the method can be used inside an electric panel, i.e. in a cabinet/enclosure, or outside such panel, it can be used to connect separated panels, etc.

A variant of an electrical conductor according to the present invention is connected to a traditional cable or busbar. In such embodiment, a traditional busbar e.g. in the back of an electric panel or a traditional cable e.g. between two electric panels may be connected to an electrical conductor of the invention. In this way a traditional cable or busbar may be connected to a component via a conductor according to the invention. Thereby, an easy connection is facilitated due to the flexibility of the electrical conductor of the invention.

However, note that manufacturing the electrical conductor, and thus accomplishing the electrical and mechanical coupling between the first end segment and the second end segment, is typically performed prior to installing the electrical conductor in the electrical installation, and prior to installing the electrical installation in the renewable energy facility. Thus, according to typical embodiments of the invention, the electrical and mechanical coupling is performed prior to installation/integration of the electrical conductor. Nevertheless, methods according to the invention are not necessarily restricted to a particular sequence of steps. Further, various methods according to the invention may comprise additional steps, such as performing digital geometry optimization, additively manufacturing the electrical conductor, and conducting current.

Summing up, a designer is designing a digital representation of the conductor according to electrical, mechanical, structural, etc. requirements in e.g. a 3D CAD software such as Solidworks. Files (digital representation) from such 3D developing tool is exported to e.g. a 3D printer, where the conductor is printed according to the CAD files.

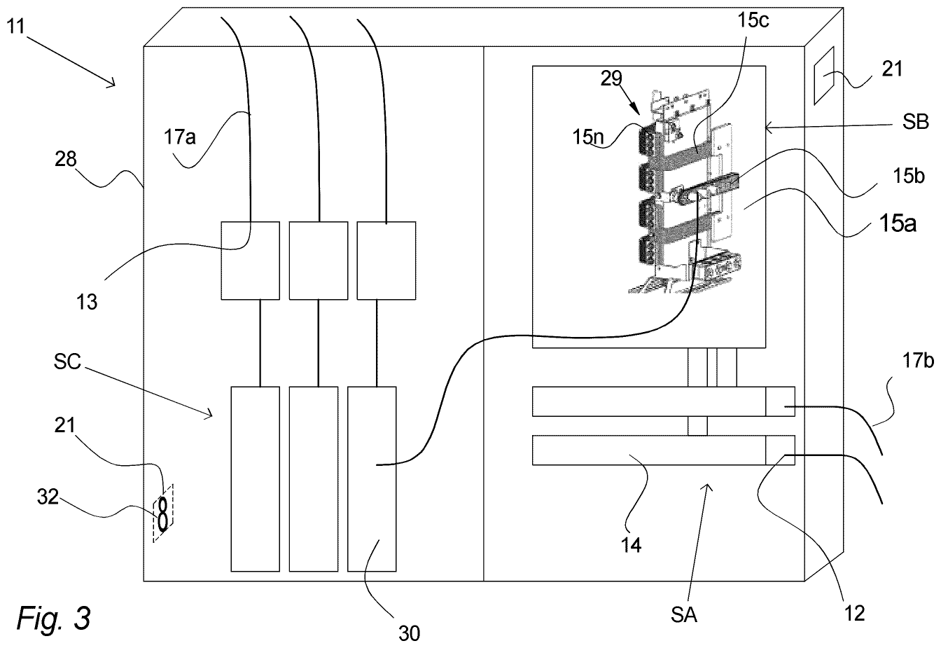

FIG. 3 illustrates an electric current distribution system 11. The distribution system 11 is supplied with power by one or more, such as three phases, via one or more, such as three or six, supply cables 17a. The supply cables 17a are mechanically and electrically connected to circuit breakers, and via the reactor 30 to power module and then to a main busbar. The main busbar comprises current output terminals 12 to which output cables 17b are connected. In this embodiment three-phased AC is input and DC is output.

The current input terminals may simply be through-holes in the main busbar through which a bolt that also passes through a cable shoe of the supply cable and thereby is clamping the cable shoe and thereby the supply cable to the main busbar.

From the main busbar 14 electrical components 29 are supplied with power via one or more transition busbars 15a-15n. Conventionally, transition busbars are made of cobber, are massive or braided conductors. The transition busbars 15 of the present invention are manufactured by additive manufacturing and thus the geometry may be tailor made to the footprint, available space, cooling capacity, current capacity, etc. that is limiting or required from the transition busbar 15. A few examples of geometry and design of a transition busbars is illustrated in FIGS. 1a-1e.

In the distribution system 11 of the present invention, the transition busbars 5a-5n are connecting the main busbars 14 with the components 29. Hence, the from the input terminals 13 to the components 29, current may be conducted by main busbars 4 and transition busbars 15. The latter may comprise predefined air gaps 6 thereby allowing the transition busbars 15 to reduce weight, be flexible, be optimized for cooling and have auxiliary functions such as described with respect to FIG. 1d.

The electrical components are typically high-power components such as power modules 29 and reactors 30 which are designed for switching and/or conducting more than 1000 A such as up to 4000 A or even more. Power modules 29 may comprise semiconductor switches such as IGBTs and may together form a three-phased invertor or rectifier module. A reactor 30 may also be referred to as a filter, transformer or simply windings around a core.

As illustrated in FIG. 3, the power modules are connected to the reactors via a cable. The reactors are connected to current input terminals 13. The output terminals 12 may be connected loads such as the utility grid or Power-to-X systems via cables.

The electrical cabinet 28 enclosing the distribution system 11 comprise openings and a fan 32 positioned in one of the openings. Hence, by controlling the fan 32, control of a flow of air through the cabinet 28 is possible.

In addition to the air flow-based cooling of components 29 in the cabinet 28, the distribution system 11 may also comprise a liquid cooling system 31 which is described in more details in relation to FIG. 7.

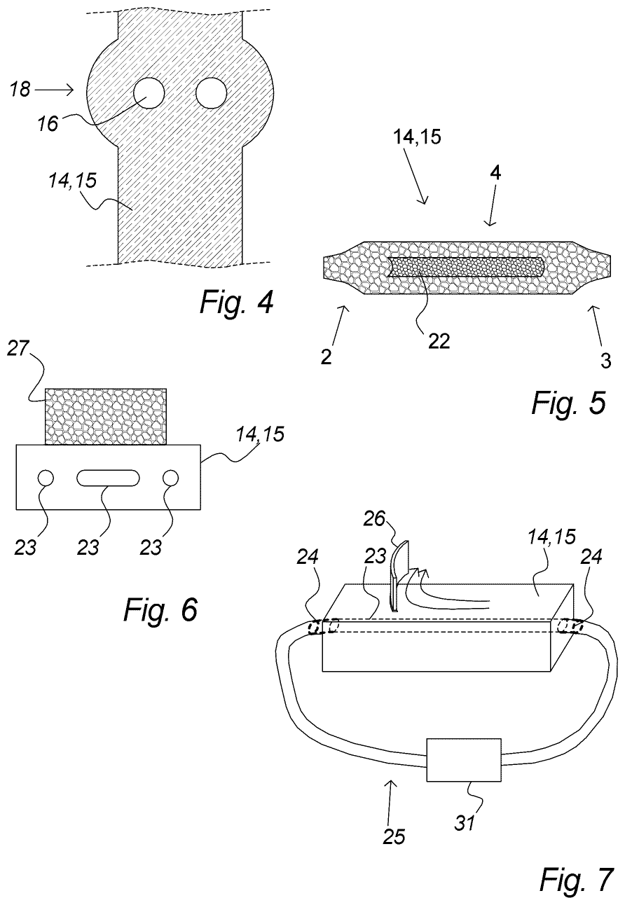

FIG. 4 illustrates part of a main busbar 14 or of a transition busbar 15. In the cross-sectional part 18 of the illustrated busbar, two through-holes 16 are illustrated. These through holes 16 obstruct the current path through the busbar so the current has the pas by turning left or right around the through holes 16. Thus, if nothing is done, more current is to be conducted by a reduced cross-sectional area. To avoid this and the heating which may follow, the density of the electrical conductor around the through-holes is greater than at the rest of the electrical conductor. This is illustrated by the two protrusions seen in the top view at the cross-sectional area 18 compensating for the material removed by the through-holes 16. In this way the cross-sectional area of the conductor is maintained in contrary to traditional busbars where cross-sectional areas are reduced if a through hole is made. This is true for any kind of through holes.

For both through-holes for terminal connection and support of the busbar, the electrical conductor may be strengthened around the holes for ensuring a better fastening of either the electrical connections or the mechanical connection. The holes may also comprise an installation surface to secure the fastening of both the electrical connections and mechanical connections to secure the electrical connections and for fastening the electrical conductor.

As mentioned, the through-holes 16 could be said to disturb and reduce the cross-sectional area of the current path through the conductor. Therefore, when removing the electrically conductive material for establishing a through-hole an additional amount of material is preferably added to secure to maintain the cross-sectional area throughout the conductor 1. Additionally, the structural property of the electrical conductor is preferably strengthened around the through-hole 16 this may be done by providing a cylinder like through-hole 16 which is solid throughout the busbar. In this way the clamping can act on this cylinder and not on the less strong web-like structure of the illustrated design of the busbar.

FIG. 5 illustrates a busbar 14, 15 in a side view having a first end 2 and a second end 3 between which a middle segment 4 is found. Here it is noted that the side is not planer or flat. Instead, a concave geometry 22 is illustrated in the middle segment 4 such concave geometry may be implanted to guide a flow or air e.g. into the interior of the busbar 14, 15 if that comprises an interior cooling channel 23 or an airy design with air gaps 6. Alternatively, the side part may have a convex geometry which may add material and volume of the busbar 14, 15, but may be even better for guiding an air flow into the interior of the busbar 14, 15.

FIG. 6 illustrates a busbar 14, 15 in an end view comprising a heat sink 27 and internal channels 23.

In an embodiment the illustrated busbar is a transition busbar 15 which may be connected to the component 29 in the first end 2 and to a main busbar 14 in the second end 3. In the middle segment 4 of the transition busbar 15 an internal channel 23 is illustrated. In this particular embodiment, the internal channel 23 is connected to a heat exchanger via a cooling loop 25 (also referred to a temperature regulation loop). Together, the internal channel 23, cooling loop 25 and heat exchanger may be referred to as a cooling system 31 (also referred to as a temperature regulation system). Such system 31 may include dedicated controllers, valves, sensors, etc. that is needed for such system to work as desired (such system is illustrated in FIG. 7).

The component 29 may e.g. be a reactor, a power module comprising semiconductor switches, a transformer, contactor, filter, etc. With this said heat is generated to some extent in almost every electrical component in distribution system 11 including the busbars. Thus, having internal cooling substituting known air cooling of the surface of a busbar lead to a better temperature regulation of the distribution system 11.

As an example, connections of two busbars, busbars and components, cables and busbars, etc. may lead to hot spots due to resistance in the connections. Accordingly, if possible, also the ends 2, 3 of the busbar 15 or where the through-holes 16 of a busbar are located is provided with internal cooling channels 23, in this case, as close thereto as possible. In this way it is ensured to remove heat as close to the source as possible to avoid a general temperature increase of the system 11.

The internal channel 23 is preferably formed during manufacturing of the conductor 1. Hence, the channel 23 is formed when the conductor is manufactured e.g. layer by layer by leaving out part of a layer. In this way, a cavity forming the channel 23 may be established. It should be noted that the channel 23 may extend through the transition between middle segment 4 and end 2, 3 and thus begin and/or end at one of these ends 2, 3.

The channel inlet and outlet may e.g. be formed as or with a channel extensions. Hence, as the busbar 11 is manufactured, the inlet and/or outlet may also be manufactured. In this way the fluid connections to the channel 23 by the loop 25 is easy to establish simply by a providing a loop pipe over the extension and e.g. in addition provide a hose clamp around the pipe. Such extension may be designed in any desired relevant way and thus be relatively long for it to end at a desired location. Such desired location may be desired e.g. with respect to service and maintenance, mounting, etc.

Alternatively, the inlet and/or outlet may be manufactured as a threaded part. Such threaded part may comprise a thread inside the busbar 15 i.e. the outer most part of the channel 23 is a threaded part. Alternatively, the threaded part may extend from the surface of the conductor 11. Such threaded parts may provide a good connection between a pipe constituting at least part of the loop 25 which may be screwed to such thread by a union nut. Hence, the inlet/outlet may be connected to the pipe of the loop 25 in different ways including the above mentioned. Examples of temperature regulation systems (cooling and heating) are provided below.

As mentioned above a busbar 14, 15 may comprise one or more heat sinks 27 according to the present invention. At least the middle segment 4 of the illustrated busbar 14, 15 comprises a heat sink 27 formed as an air penetrating heat sink.

The remaining part of the conductor/conductor surface may have the same geometry as the heat sink 27 and thus in practise the entire busbar 14, 15 may work as a heat sink.

An air penetrating heat sink 27 should be understood as a structure of the current conducting middle segment 4 that allows a flow of air to travel through while current is conducted through this structure. Hence, an air penetrating structure comprises a plurality of air gaps 6 that may be uniform as in a web structure (see FIG. 1b) or different as in a bionic design (see FIG. 1c).

Note that the conducting cross-sectional area of the busbar 14, 15 should be maintained the same or at least above a minimum cross-sectional area both where no heat sink is implemented and where a heat sink is implemented. Hence, when manufacturing the busbar 14, 15 with integrated heat sink 27, the airgaps 6 establishing the air penetrating design may be compensated for e.g. by letting the physical size of the busbar grow to maintain a desired minimum cross-sectional area.

In addition to the cooling system 31 mentioned above, FIG. 7 illustrates an air guide 26. Independent if the surface of the middle segment 4 and ends 2, 3 o the busbar 14, 15 is airy or flat an air guide 26 e.g. as illustrated may be provided. The illustrated air guide 11 is a protrusion. The air guide 26 may also be a recess or a combination.

Removable air guides 26 may be connected to the busbar 14, 15, more specifically to guide fasteners of the busbar 14, 15. A guide fastener may by a recess or protrusion used to attach an external or additional air guide. Such guide fastener is advantageous in that not only does they facilitate an easy way of attaching an air guide to the busbar 14, 15, but they also ensure that the location of the removably attached air guide is positioned exactly where it is intended. Such location is typically found from experience or simulation of layout of an electrical cabinet in which the busbar 14, 15 is installed.

The removable air guide may comprise a protruding part or recess part which is configure for engaging with the guide fastener. The structure of the air guide may be so that it forces the recess/protrusion together or it may comprise a spring that ensures fastening of the air guide to the busbar. In order to remove the air guide a force may be applied a predetermined location of the air guide to release the recess/protrusion from the guide fastener.

From the above it is now clear that the invention relates to an electric distribution system comprising a transition busbar which is manufactured by an additive manufacturing process. This transition busbar may have different geometries with different properties.

The invention has been exemplified above with the purpose of illustration rather than limitation with reference to specific embodiments. Details of specific embodiment have been provided in order to understand the aim of the invention. Please note, that detailed descriptions of well-known systems, devices, circuits, and methods have been omitted so as to not obscure the description of the invention with unnecessary details.

### LIST

1. Electrical conductor
2. First end
3. Second end
4. Middle segment
5. Conductor branch
   a. Longitudinal conductor branch
   b. Transversal conductor branch
6. Air gap
   a. Longitudinal airgap (in X direction)
   b. Transversal airgap (in Y direction)
   c. Vertical airgap (in Z direction)
7. First terminal
8. Second terminal
9. Intersection point
10. Terminal hole
11. Electrical current distribution system
12. Current output terminals
13. Current input terminals
14. Main busbar
15. Transition busbar
16. Through-hole
17. Supply cable
18. Cross-section part
19. Central body segment
20. Inductor part
21. Ventilation opening
22. Concave geometry
23. Internal channel
24. External cooling channel
25. Cooling loop
26. Air guide
27. Integrated heat sink
28. Electric cabinet
29. Electrical component
30. Reactor
31. Cooling system
32. Fan

1-29. (canceled)

30. An electric current distribution system comprises:
one or more current input terminals;
one or more main busbars;
a plurality of transition busbars; and
one or more current output terminals,
wherein at least one of the one or more main busbars or at least one of the plurality of transition busbars are manufactured by an additive manufacturing process with a first end segment, a second end segment and a middle segment therebetween, and so that a cross-sectional area of the middle segment at one distance from the first end segment may be different from a cross-sectional area of the middle segment at a second distance from the first end segment.

31. The electric current distribution system according to claim 30, wherein a cross-sectional part of at least one of the one or more main busbars or one of the plurality of transition busbars comprising a through-hole and wherein the cross-sectional part of the at least one of the one or more main busbars or one of the plurality of transition busbars is increased.

32. The electric current distribution system according to claim 30, wherein the at least one of the one or more main busbars or one of the plurality of transition busbars has a wedge-shaped geometry.

33. The electric current distribution system according to claim 30, wherein at least one of the one or more main busbars or one of the plurality of transition busbars is manufactured at least partly with a concave geometry in a surface of a middle segment or in one of a first end and a second end of the at least one of the one or more main busbars or one of the plurality of transition busbars.

34. The electric current distribution system according to claim 30, wherein at least one of the first end and the second end is monolithically formed with the middle segment.

35. The electric current distribution system according to claim 30, wherein at least one of the one or more main busbars or one of the plurality of transition busbars are manufactured with an airy geometry.

36. The electric current distribution system according to claim 30, wherein an electrical conductor has a resonance vibration frequency of at least 5 Hz.

37. The electric current distribution system according to claim 30, wherein at least a middle segment of at least one of the one or more main busbars or one of the plurality of transition busbars includes at least one internal channel.

38. The electric current distribution system according to claim 37, wherein the at least one internal channel is included in a cooling loop and configured to guide a cooling fluid circulated in the cooling loop through an interior of the at least one of the main busbars or the transition busbars via the at least one internal channel.

39. The electric current distribution system according to claim 30, wherein at least one of the one or more main busbars or one the plurality of transition busbars comprises at least one air guide.

40. The electric current distribution system according to claim 39, wherein the at least one air guide is removably attached to one of the one or more main busbars or one of the plurality of transition busbars.

41. The electric current distribution system according to claim 30, wherein at least one of the one or more main busbars or one of the plurality of transition busbar comprises at least one integrated heat sink.

42. The electric current distribution system according to claim 41, wherein the at least one heat sink is removably attached to one of the one or more main busbars or one of the plurality of transition busbars.

43. The electric current distribution system according to claim 30, wherein the cross-sectional area at the first distance is determined by current conducted by one cable connected to the middle segment and the cross-sectional area at the second distance is determined by current conducted by two or more cables connected to the middle segment.

44. An electric cabinet assembly comprising:
an electric cabinet;
a power conduction section comprising one or more main busbars;
a power handling section comprising a plurality of electrical components; and
a plurality of transition busbars,
wherein at least part of the plurality of electrical components of the power handling section is connected to one of the one or more main busbar via one of the plurality of transition busbars, and
wherein at least one of the plurality of transition busbars is manufactured by an additive manufacturing process with a first end segment, a second end segment and a middle segment therebetween, so that a cross-sectional area of the middle segment at one distance from the first end segment may be different from a cross-sectional area of the middle segment at a second distance from the first end segment.

45. The electric cabinet assembly according to claim 44, further comprising a cooling system configured for local cooling of at least one of the one or more main busbars or one of the plurality of transition busbars.

46. The electric cabinet assembly according to claim 44, wherein at least one of the one or more main busbars or one of the plurality of transition busbars are manufactured with an internal channel configured for conducting a fluid.

47. The electric cabinet assembly according to claim 44, wherein at least one of the one or more main busbars or at least one of the plurality of transition busbars is cooled by a fan.

48. The electric cabinet assembly according to claim 44, wherein the cross-sectional area at the first distance is determined by current conducted by one cable connected to the middle segment and the cross-sectional area at the second distance is determined by current conducted by two or more cables connected to the middle segment.
